(19) United States
(12) Patent Application Publication
(10) Pub. No.: US 2012/0109486 A1
(43) Pub. Date: May 3, 2012

(54) METHOD AND A DEVICE FOR MONITORING A REDUNDANT MEASUREMENT SYSTEM

(75) Inventors: Stéphane ECOUTIN, Dammarie Les Lys (FR); Xavier Flandrois, Cesson (FR); Jean-Rémi André Masse, Saint-Cloud (FR)

(73) Assignee: SNECMA, Paris (FR)

(21) Appl. No.: 13/280,796

(22) Filed: Oct. 25, 2011

(30) Foreign Application Priority Data
Nov. 2, 2010 (FR) 10 58985

(51) Int. Cl. G06F 7/00

(52) U.S. Cl. 701/100

(57) ABSTRACT

The invention relates to monitoring a redundant measurement system of an aeroengine by means of an electronic unit. The monitoring comprises a step of obtaining first measurements of a physical magnitude measured in said engine, and a step of obtaining second measurements of said physical magnitude. According to the invention, the method includes a step of calculating detection residues as a function of differences between the first and second measurements, a step of determining a mean-jump flag, a step of determining a variance-jump flag, a step of determining a change-of-slope flag, and a step of generating a diagnostic notice as a function of said mean-jump flag, of said variance-jump flag, and of said change-of-slope flag.

### BACKGROUND OF THE INVENTION

The invention relates to the general field of aviation.

More particularly, it relates to monitoring a redundant measurement system of an aeroengine. It is known to monitor measurements performed by sensors in such a redundant measurement system. For example, the integrity test consists in detecting a short circuit or an open circuit in the measurement system. The zone test serves to verify that a measurement is not an outlier, by comparing it with the accuracy of the sensor or the physical limits of the sensor.

Those known tests serve to detect a breakdown of the redundant measurement system. Nevertheless, they do not enable the appearance of a breakdown to be predicted. It is therefore not possible to make provision for maintenance before the breakdown appears. Furthermore, when a breakdown is detected, those tests give no indication about the type or the location of the breakdown. During the subsequent maintenance operation, it is therefore necessary to search for the location of the breakdown. Finally, those tests make it necessary to select comparison thresholds that enable a non-detected breakdown to be avoided, which can lead to the appearance of false alarms.

### OBJECT AND SUMMARY OF THE INVENTION

An object of the present invention is to provide a monitoring method that does not present at least some of the above-mentioned drawbacks of the prior art.

To this end, the invention provides a method of monitoring a redundant measurement system for an aeroengine, the method being executed by an electronic unit of said engine, said monitoring method comprising:

a step of obtaining first measurements of a physical magnitude measured in said engine; and

a step of obtaining second measurements of said physical magnitude;

wherein the method comprises:

a step of calculating detection residues as a function of differences between the first measurements and the second measurements;

a step of determining a mean-jump flag representing a difference between the mean of the distribution of detection residues and the mean of a reference distribution;

a step of determining a variance-jump flag representing a difference between the variance of the distribution of the detection residues and the variance of the reference distribution;

a step of determining a change-of-slope flag representing a difference between the slope of the distribution of the detection residues and the slope of the reference distribution; and

a step of generating a diagnostic notice as a function of said mean-jump flag, of said variance-jump flag, and of said change-of-slope flag.

Depending on the mean jump, variance jump, and change-of-slope flags, the invention enables faults to be detected in the redundant measurement system. Knowledge of such faults then enables the appearance of a breakdown to be predicted.

In an implementation, the monitoring method comprises:

a step of obtaining modeled values of said physical magnitude;

a step of calculating first location residues as a function of differences between the first measurements and the modeled values;

a step of calculating second location residues as a function of the differences between the second measurements and the modeled values;

a step of determining a first mean-jump flag representing a difference between the mean of the distribution of the first location residues and the mean of a first reference distribution;

a step of determining a second mean-jump flag representing a difference between the mean of the distribution of the second location residues and the mean of a second reference distribution;

a step of determining a first variance-jump flag representing a difference between the variance of the distribution of the first location residues and the variance of the first reference distribution;

a step of determining a second variance-jump flap representing a difference between the variance of the distribution of the second location residues and the variance of the second reference distribution;

a step of determining a first change-of-slope flag representing a difference between the slope of the distribution of the first location residues and the slope of the first reference distribution;

a step of determining a second change-of-slope flag representing a difference between the slope of the distribution of the second location residues and the slope of the second reference distribution; and

a step of generating a notice concerning the location of a fault as a function of said first and second mean-jump flags, of said first and second variance-jump flags, and of said first and second change-of-slope flags.

The mean-jump flag may be determined by a Wald test. The variance-jump flag may also be determined by a Wald test. The change-of-slope flag may be determined by a Student's test.

In an implementation, the method includes a step of detecting a stabilized stage, said detection residues being calculated as a function of differences between the first measurements and the second measurements as obtained during the stabilized stage.

The step of determining a mean-jump flag, the step of determining a variance-jump flag, and the step of determining a change-of-slope flag may be repeated throughout a flight of the aircraft, the method including a step of generating a maintenance notice as a function of the flags determined during successive repeats.

In a particular implementation, the various steps of the monitoring method are determined by computer program instructions.

Consequently, the invention also provides a computer program on a data medium, the program being suitable for being implemented in a monitoring device or more generally in a computer, the program including instructions adapted to implementing steps of a monitoring method as described above.

The method may use any programming language, and it may be in the form of source code, object code, or of code intermediate between source code and object code, such as in a partially compiled form, or in any other desirable form.

The invention also provides a computer readable data medium that includes instructions of a computer program as mentioned above.

The data medium may be any entity or device capable of storing the program. For example, the medium may comprise a storage medium such as a read-only memory (ROM), e.g. a compact disk (CD) ROM, or a microelectronic circuit ROM, or indeed magnetic recording means, e.g. a floppy disk or a hard disk.

Furthermore, the information medium may be a transmission medium such as an electrical or optical signal, suitable for being conveyed via an electrical or optical cable, by radio, or by other means. The program of the invention may in particular be downloaded from a network of the Internet type.

Alternatively, the data medium may be an integrated circuit having the program incorporated therein, the circuit being adapted to execute or to be used in the execution of the method in question.

Finally, the invention provides a monitoring device for monitoring a redundant measurement system of an aeroengine, the device comprising:

means for obtaining first measurements of a physical magnitude that is measured in said engine; and

means for obtaining second measurements of said physical magnitude;

wherein the device comprises:

means for calculating detection residues as a function of differences between the first measurements and the second measurements;

means for determining a mean-jump flag representing a difference between the mean of the distribution of detection residues and the mean of a reference distribution;

means for determining a variance-jump flag representing a difference between the variance of the distribution of the detection residues and the variance of the reference distribution;

means for determining a change-of-slope flag representing a difference between the slope of the distribution of the detection residues and the slope of the reference distribution; and

means for generating a diagnostic notice as a function of said mean-jump flag, of said variance-jump flag, and of said change-of-slope flag.

The advantages and characteristics of this monitoring device are similar to those of the monitoring method in accordance with the invention.

### BRIEF DESCRIPTION OF THE DRAWING

Other characteristics and advantages of the present invention appear from the following description made with reference to the accompanying drawing which shows an implementation having no limiting character. In the figures:

FIG. 1 shows a redundant measurement system of an aeroengine; and

FIG. 2 shows the main steps in a monitoring method in an implementation of the invention.

### DETAILED DESCRIPTION OF AN IMPLEMENTATION

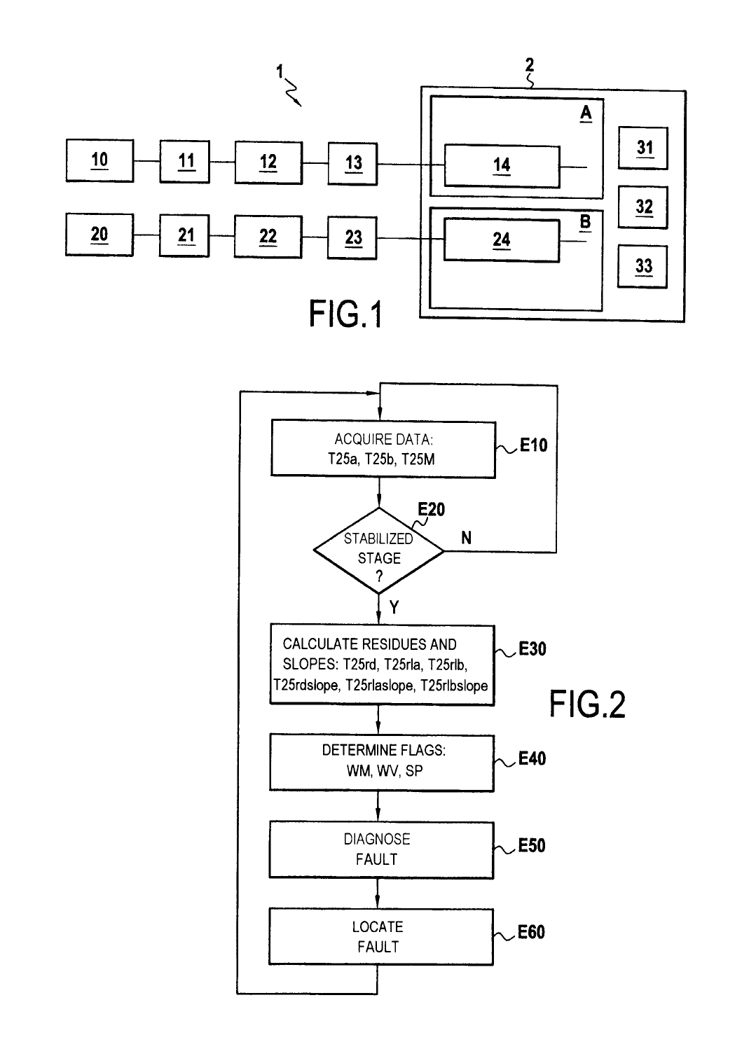

FIG. 1 shows a redundant measurement system 1. The measurement system 1 comprises an electronic unit 2, a sensor 10 connected to the electronic unit 2 via a connector 11, a harness 12, and a connector 13, and a sensor 20 connected to the electronic unit 2 via a connector 21, a harness 22, and a connector 23.

By way of example, the electronic unit 2 is the engine computer (also known as a full authority digital engine controller (FADEC)) and it presents two-channel operation, represented in FIG. 1 by a channel A and a channel B. The channel A includes a conditioning module 14 for conditioning the signal coming from the sensor 10, and the channel B includes a conditioning module 24 for conditioning the signal coming from the sensor 20.

The sensors 10 and 20 are arranged in the engine so as to measure the same physical magnitude. Thus, the electronic unit 2 obtains over the channel A first measurements of the physical magnitude, and over the channel B, second measurements of the physical magnitude.

The present invention relates to such a redundant measurement system. It may be a measurement system that is totally redundant, as shown in FIG. 1. In a variant, it may be a system that is partially redundant, having a single sensor that transmits two measurement signals to the electronic unit. The invention is described below with reference to the totally redundant measurement system 1 of FIG. 1.

The steps of the monitoring method in an implementation of the invention are implemented by a computer program executed by the electronic unit 2. For this purpose, the electronic unit 2 comprises a processor 31, a ROM 32 having the computer program stored therein, and a random access memory (RAM) 33 enabling the computer program to be executed by the processor.

Thus, the electronic unit 2 constitutes a monitoring device in the meaning of the invention and the ROM 32 constitutes a data medium in the meaning of the invention.

In operation, the electronic unit 2 acquires the signals coming from the sensors 10 and 20. Below, the invention is described with reference to an embodiment in which the physical magnitude measured by the sensors 10 and 20 is T25, i.e. the inlet temperature to the high-pressure compressor of the engine. Naturally, the invention may apply to other physical magnitudes.

FIG. 2 shows the main steps of a monitoring method in an implementation of the invention.

In step E10, the electronic unit 2 obtains and stores in memory the following data for a sample i:

T25a, the measurement of the temperature T25 via the channel A;

T25b, the measurement of the temperature T25 via the channel B;

T25M, a model of the temperature T25 determined as a function of other parameters;

N2, the speed of the high-pressure spool of the engine;

N1, the speed of the low-pressure spool of the engine; and

t, the instant of acquisition.

After executing step E10 several times, the electronic unit 2 then has in memory a table that contains the above-mentioned data for a plurality of successive samples.

Thereafter, in step E20, the electronic unit 2 detects a stage of stabilized operation of the engine (cruising flight, or stationary on the ground, for example), as a function of the speed N2. The following steps E30 to E60 are executed if a stabilized stage is detected.

In step E30, the electronic unit 2 calculates and stores in memory the following data, for the latest sample i:

T25rd, the detection residue: T25rd=|T25a−T25b|;

T25rla, the location residue for the channel A: T25rla=|T25a−T25M|; and

T25rlb, the location residue for the channel B: T25rlb=|T25b−T25M|.

The electronic unit 2 thus stores in memory the residues of the sample i and of the preceding samples together with the instants t of the samples. This data enables the electronic unit also to calculate the following data:

T25rdslope, the slope of a straight line determined by linear regression as a function of the detection residues T25rd for the stored samples;

T25rlaslope, the slope of a straight line determined by linear regression as a function of the location residues T25rla for the stored samples; and

T25rlbslope, the slope of a straight line determined by linear regression as a function of the location residues T25rlb for the stored samples.

The electronic unit 2 also calculates and stores in memory a centered-and-reduced value for each of the values T25rd, T25rla, and T25rlb of the sample i:

T25rd^{cr}=(T25rd−M⁰rd)/√V⁰rd

T25rla^{cr}=(T25rla−M⁰rla)/√V⁰rla

T25rlb^{cr}=(T25rlb−M⁰rlb)/√V⁰rlb

The reference values M⁰rd and V⁰rd are respectively the mean and the variance of a reference distribution of detection residues T25rd. The reference distribution is a distribution that is considered to be sound. For example, the values of M⁰rd and V⁰rd are determined as a function of the distribution of the detection residues during a flight that is considered to be sound, or during a plurality of flights that are considered to be sound.

In corresponding manner, M⁰rla, V⁰rla, M⁰rlb, and V⁰rlb are the means and the variances of reference distributions that are considered to be sound for the location residues via the channels A and B.

Thereafter, in step E40, the electronic unit 2 determines and stores in memory flags that are representative of faults of the measurement system 1. More precisely, the electronic unit 2 determines a flag WM for a jump in the mean, a flag WV for a jump in the variance, and a flag SP for a change of slope.

The mean-jump flag WM seeks to detect a difference in the mean between the residues T25rd of the measured samples compared with the above-mentioned reference distribution. The mean-jump flag WM may be determined, for example, by a Wald statistical test on the values of T25rd^{cr}. Under such circumstances, the Wald test corresponds to the following assumptions:

H0: m=0, σ²=1

H1: m=b, σ²=1

In other words, the starting assumption is that the variance remains constant and that the mean jumps through an amplitude |b|. To simplify the notation, the centered and reduced detection residue for the sample i is written:

xi=T25rd^{cr}(i)

Starting from a Gaussian distribution of measurements, the probability densities are as follows:

$${P}_{0} ( {x}_{t} ) = \frac{1}{\sqrt{2 π}} exp ( - \frac{{x}_{i}^{2}}{2} )$$

$${P}_{1} ( {x}_{t} ) = \frac{1}{\sqrt{2 π}} exp ( - \frac{{( {x}_{i} - b )}^{2}}{2} )$$

The ratio of these densities is as follows:

$$\frac{{P}_{1} ( {x}_{i} )}{{P}_{0} ( {x}_{i} )} = exp ( {b}^{*} ( {x}_{i} - \frac{b}{2} ) )$$

Thus, for n samples, the likelihood ratio is written as follows:

$$Vn = {\prod }_{i = 1}^{n} \frac{{P}_{1} ( {x}_{i} )}{{P}_{0} ( {x}_{i} )} = exp ( {b}^{*} ( {\sum }_{i = 1}^{n} {x}_{i} - n \frac{b}{2} ) ) )$$

The assumption H0 is applied if Vn≦S1 (S1 is the lower Wald threshold).

The assumption H1 is applied if Vn≧S2 (S2 is the upper Wald threshold).

Finally, neither H0 nor H1 is applied (no decision) if:

S1<Vn<S2.

The thresholds S1 and S2 may be selected as a function of the desired non-detection probability Pnd and the desired false alarm probability Pf.

The above-mentioned conditions may also be written as follows:

$$H 0 \text{:} {\sum }_{i = 1}^{n} ( \vert {x}_{i} \vert - \frac{\vert b \vert}{2} ) < \frac{Log ( S 1 )}{\vert b \vert}$$

$$H 1 \text{:} {\sum }_{i = 1}^{n} ( \vert {x}_{i} \vert - \frac{\vert b \vert}{2} ) > \frac{Log ( S 2 )}{\vert b \vert}$$

These conditions show that the result of the Wald test is based on an accumulated sum for successive samples. There is thus a risk of delay in detecting a jump in the mean before the sum exceeds the threshold corresponding to S2. In order to make detection quasi-instantaneous, the following detection procedure is used:

For each new sample, Vn is calculated by multiplying the value of Vn as determined for the preceding sample by the factor corresponding to the new sample.

Thereafter, if Vn<Si, that means there has been no jump in the mean. The electronic unit 2 thus determines that the flag WM is equal to 0. Furthermore, the value retained for Vn is the greatest value Vn⁻ that satisfies

Vn<S1−m_Tol

(where m_Tol is a degree of tolerance added to take uncertainties into account). The value Vn⁻ represents the minimum value that the accumulated sum may have, i.e.:

If Vn<Vn⁻ then Vn:=Vn⁻

Thus, when calculating Vn for the following sample, the starting point is a value Vn that is close to the threshold S1, thereby serving to accelerate detection of the appearance of a fault.

Correspondingly, if Vn>S2, that indicates that there is a jump in the mean. The electronic unit 2 then determines that the flag WM is equal to 1. Furthermore, the value retained for Vn is the smallest value Vn⁺ that satisfies:

Vn>S2+m_Tol

The value Vn⁺ represents the maximum value that may be taken by the accumulated sum, i.e.:

If Vn>Vn⁺ then Vn:=Vn⁺

Thus, when calculating Vn for the following sample, the starting value for Vn is close to the threshold S2, thereby accelerating detection of the disappearance of a fault.

Finally, if S1<Vn<S2 (no decision), then Vn remains unchanged.

The variance-jump flag WV seeks to detect a difference in variance between the residues T25rd of the measured samples compared with the above-mentioned reference distribution. By way of example, the variance-jump flag WV is determined by a Wald statistical test on the values of T25rd^{cr}. Under such circumstances, the Wald test corresponds to the following assumptions:

H0: m=0, σ²=1

H1: m=0, σ²>1

The procedure is similar to that described above for the mean-jump flag WM: comparing the likelihood ratio Vn with the thresholds S1 and S2 makes it possible to decide whether to use assumption H0 or H1. Depending on which assumption is used, the electronic unit 2 determines that the value of the variance-jump flag WV is 0 or 1, respectively. The decision procedure likewise conserves values Vn⁻ or Vn⁺ in order to accelerate decision-making.

The slope change flag SP seeks to detect a difference of slope between a line determined by linear regression of the residues T25rd of the measured samples, compared with a corresponding line determined from the above-mentioned reference distribution. The slope change flag SP may be determined, e.g. by using a Student's statistical test. Below, the slope T25rdslope calculated up the sample i is written β(i) in order to simplify the notation.

The distribution of the slopes β(i) follows a Student's relationship. In the reference state, the distribution of the slopes β(i) has a mean β⁰ and a variance V(β). The Student's statistic is calculated for each sample i as follows:

$$ST ( i ) = \frac{β ( i ) - {β}^{0}}{\sqrt{V ( β )}}$$

By way of example, detecting a change in slope may make use of thresholds at 3σ and at 6σ for positive z scores |ST(i)|: if |St(i)|<3σ threshold, then there is no change of slope and the electronic unit 2 determines that the flag SP is equal to 0. If |St(i)|<6σ threshold, then there has been a change of slope and the electronic unit 2 determines that the flag SP is equal to 1. Between those two thresholds, the situation is undecided.

In step E50, the electronic unit 2 generates a diagnostic notice as a function of the flags WM, WV, and SP as determined in step E40. The notice that is generated in step E50 specifies the type of fault that has been determined as a function of an expert matrix that specifies, for each triplet of values for the flags WM, WV, and SP, the type of fault that has been encountered on the measurement system 1:

| WM | WV | SP | Type of fault |
|---|---|---|---|
| 0 | 0 | 1 | Drift |
| 0 | 1 | 0 | Noise |
| 0 | 1 | 1 | Drift |
| 1 | 0 | 0 | Bias |
| 1 | 0 | 1 | Drift |
| 1 | 1 | 0 | Intermittent contacts |
| 1 | 1 | 1 | Drift |

After detecting a fault and identifying its type in step E50, the electronic unit 2 locates the fault in step E60. For this purpose, the calculation of the flags WM, WV, and SP in step E40 is repeated, but now using the location residues T25rla and T25rlb. Thus, a fault indicated by the flags determined from the location residues for channel A enables the fault to be located in channel A. Correspondingly, a fault indicated by the flags determined from the location residues for channel B enables the fault to be located in channel B.

At the end of the flight, the electronic unit 2 thus stores in its memory, for each sample i, the flags WM, WV, and SP as determined in steps E40 and E60. The set of these flags represents the history of the faults that have occurred in the measurement system 1 during the flight. This history of faults makes it possible, in combination with a model for degradation of a measurement system, to predict the appearance of a breakdown and to generate a maintenance notice for the measurement system 1 before the breakdown appears. By means of the flags determined in step E60, the maintenance notice may specify which portion of the measurement system 1 needs to be subjected to maintenance.

As explained above, the invention may be implemented by a computer program executed by the electronic unit 2. Thus, it may be observed that implementing the invention does not require any hardware modification to the measurement system 1 nor to the aeroengine.

Furthermore, the invention makes it possible to generate a maintenance notice without requiring any manual intervention in operation.

In addition, since the maintenance notice is generated while taking account of a history of all the faults that occurred during a flight, it is possible to limit the appearance of false alarms compared with a notice based on spot data only.

What is claimed is:

1. A method of monitoring a redundant measurement system for an aeroengine, the method being executed by an electronic unit of said engine, said monitoring method comprising:
a step of obtaining first measurements of a physical magnitude measured in said engine; and
a step of obtaining second measurements of said physical magnitude;
wherein the method comprises:
a step of calculating detection residues as a function of differences between the first measurements and the second measurements;
a step of determining a mean-jump flag representing a difference between the mean of the distribution of detection residues and the mean of a reference distribution;
a step of determining a variance-jump flag representing a difference between the variance of the distribution of the detection residues and the variance of the reference distribution;
a step of determining a change-of-slope flag representing a difference between the slope of the distribution of the detection residues and the slope of the reference distribution; and
a step of generating a diagnostic notice as a function of said mean-jump flag, of said variance-jump flag, and of said change-of-slope flag.

2. A monitoring method according to claim 1, comprising:
a step of obtaining modeled values of said physical magnitude;
a step of calculating first location residues as a function of differences between the first measurements and the modeled values;
a step of calculating second location residues as a function of the differences between the second measurements and the modeled values;
a step of determining a first mean-jump flag representing a difference between the mean of the distribution of the first location residues and the mean of a first reference distribution;
a step of determining a second mean-jump flag representing a difference between the mean of the distribution of the second location residues and the mean of a second reference distribution;
a step of determining a first variance-jump flag representing a difference between the variance of the distribution of the first location residues and the variance of the first reference distribution;
a step of determining a second variance-jump flap representing a difference between the variance of the distribution of the second location residues and the variance of the second reference distribution;
a step of determining a first change-of-slope flag representing a difference between the slope of the distribution of the first location residues and the slope of the first reference distribution;
a step of determining a second change-of-slope flag representing a difference between the slope of the distribution of the second location residues and the slope of the second reference distribution; and
a step of generating a notice concerning the location of a fault as a function of said first and second mean-jump flags, of said first and second variance-jump flags, and of said first and second change-of-slope flags.

3. A monitoring method according to claim 1, wherein said mean-jump flag is determined by a Wald test.

4. A monitoring method according to claim 1, wherein said variance-jump flag is determined by a Wald test.

5. A monitoring method according to claim 1, wherein said change-of-slope flag is determined by a Student's test.

6. A monitoring method according to claim 1, including a detection step of detecting a stabilized stage, said detection residues being calculated as a function of differences between the first measurements and the second measurements as obtained during the stabilized stage.

7. A monitoring method according to claim 1, wherein the step of determining a mean-jump flag, the step of determining a variance-jump flag, and the step of determining a change-of-slope flag are repeated throughout a flight of the aircraft, the method including a step of generating a maintenance notice as a function of the flags determined during successive repeats.

8. A computer program including instructions for executing steps of the monitoring method according to claim 1 when said program is executed by a computer.

9. A computer readable storage medium having a computer program stored therein that includes instructions for executing the steps of the monitoring method according to claim 1.

10. A monitoring device for monitoring a redundant measurement system of an aeroengine, the device comprising:
means for obtaining first measurements of a physical magnitude that is measured in said engine; and
means for obtaining second measurements of said physical magnitude;
wherein the device comprises:
means for calculating detection residues as a function of differences between the first measurements and the second measurements;
means for determining a mean-jump flag representing a difference between the mean of the distribution of detection residues and the mean of a reference distribution;
means for determining a variance-jump flag representing a difference between the variance of the distribution of the detection residues and the variance of the reference distribution;
means for determining a change-of-slope flag representing a difference between the slope of the distribution of the detection residues and the slope of the reference distribution; and
means for generating a diagnostic notice as a function of said mean-jump flag, of said variance-jump flag, and of said change-of-slope flag.
